(19) United States
(12) Patent Application Publication
(10) Pub. No.: US 2024/0172151 A1
(43) Pub. Date: May 23, 2024

(54) SYSTEMS, METHODS, AND NON-TRANSITORY PROCESSOR-READABLE MEDIA FOR DETERMINING DEMODULATION REFERENCE SIGNALS

(71) Applicant: ZTE CORPORATION, Shenzhen (CN)

(72) Inventors: Kai XIAO, Shenzhen (CN); Xing LIU, Shenzhen (CN); Jing SHI, Shenzhen (CN); Peng HAO, Shenzhen (CN); Fei XUE, Shenzhen (CN)

(73) Assignee: ZTE CORPORATION, Shenzhen (CN)

(21) Appl. No.: 18/532,595

(22) Filed: Dec. 7, 2023

Related U.S. Application Data
(63) Continuation of application No. PCT/CN2021/130791, filed on Nov. 16, 2021.

(51) Int. Cl. H04W 56/00; H04L 5/00; H04W 72/0457; H04W 72/232

(52) U.S. Cl. CPC H04W 56/0015; H04L 5/0051; H04W 72/0457; H04W 72/232

(57) ABSTRACT

Systems, methods, non-transitory processor-readable media, and apparatuses for determining modulation reference signals include but not limited to receiving a Synchronization Signal (SS)/Physical Broadcast Channel (PBCH) block, the SS/PBCH block includes Demodulation Reference Signal (DMRS) Resource Elements (REs). A portion of a bandwidth of the SS/PBCH block is outside of a bandwidth of a system bandwidth. A mapping between a DMRS sequence and the DMRS REs is determined. A mapping between a Control-Chanel Element (CCE) and a first resource is determined.

### CROSS-REFERENCE TO RELATED APPLICATION

This application claims the benefit of priority under 35 U.S.C. § 120 as a continuation of International Patent Application No. PCT/CN2021/130791, filed on Nov. 16, 2021, the disclosure of which is incorporated herein by reference in its entirety.

### TECHNICAL FIELD

The disclosure relates generally to wireless communications and, more particularly, to systems, methods, and non-transitory processor-readable media for determining demodulation reference signals.

### BACKGROUND

In 5th Generation communication network (5G), the supported minimum bandwidth is 5 MHz. In some scenarios (such as railway implementations), the available frequency-domain resources of some operators may be less than 5 MHz. When the defined minimum bandwidth is less than 3.6 MHz, the Resource Block (RB) of the Synchronization Signal (SS)/Physical Broadcast Channel (PBCH) block is punctured. As a result, the integrity of the Demodulation Reference Signal (DMRS) sequence in PBCH is diminished, resulting in performance degradation or failure.

In addition, the current Control Resource Set (CORESET) for Type0 Physical Downlink Control Channel (PDCCH) Common Search Space (CSS), or CORESET0, occupies at least 24 RBs in the frequency-domain resource, while the frequency-domain bandwidth of 3.6 MHz contains at most 20 RBs. If CORESET0 is not enhanced, some Control-Chanel Element (CCE) will be mapped outside the valid bandwidth.

### SUMMARY

In some arrangements, systems, methods, apparatuses, and non-transitory computer-readable media allow receiving, by a wireless communication device from a base station, a SS)/PBCH block, the SS/PBCH block includes DMRS REs. A portion of a bandwidth of the SS/PBCH block is outside of a bandwidth of a system bandwidth. The wireless communication device determines a mapping between a DMRS sequence and the DMRS REs The wireless communication device determines a mapping between a CCE and a first resource.

In some arrangements, systems, methods, apparatuses, and non-transitory computer-readable media allow mapping a DMRS sequence to the DMRS REs, mapping a CCE to a first resource, and sending, by a base station to a wireless communication device, a SS/PBCH block. The SS/PBCH block includes DMRS REs. A portion of a bandwidth of the SS/PBCH block is outside of a bandwidth of a system bandwidth.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 is a diagram illustrating an example cellular communication network, in accordance with some arrangements.

FIG. 2 illustrates block diagrams of an example base station and an example user equipment device, in accordance with some arrangements.

FIG. 3 is a diagram illustrating an example of an SS/PBCH block, according to various arrangements.

FIG. 4(a) is a schematic diagram illustrating an scenario in which at least one RB is punctures, according to various arrangements.

FIG. 4(b) is a schematic diagram illustrating an scenario in which at least one RB is punctures, according to various arrangements.

FIG. 4(c) is a schematic diagram illustrating an scenario in which at least one RB is punctures, according to various arrangements.

FIG. 5 is a diagram illustrating an example mapping method for mapping elements of the DMRS sequence to DMRS REs, according to various arrangements.

FIG. 6 is a diagram for determining boundary alignment, according to various arrangements.

FIG. 7 is a flowchart diagram illustrating an example method for determining demodulation reference signals, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

In the current 5G system, the minimum bandwidth supported is 5 MHz. The frequency points are limited to 0-3000 MHz. Currently, the SSB block occupies 20 RBs in the frequency-domain and 4 consecutive time-domain symbols. The first symbol is mapped to Primary Synchronization Signal (PSS). The third symbol is mapped to Secondary Synchronization Signal (SSS) and PBCH. The second and fourth symbols are mapped to PBCH. Each PBCH RB includes 3 Demodulation Reference Signal (DMRS) Resource Elements (REs) for channel estimation. The DMRS sequence is mapped from the low frequency to high frequency in the RE of each time-domain symbol. CORESET0 occupies at least 24 RBs of the frequency-domain resource.

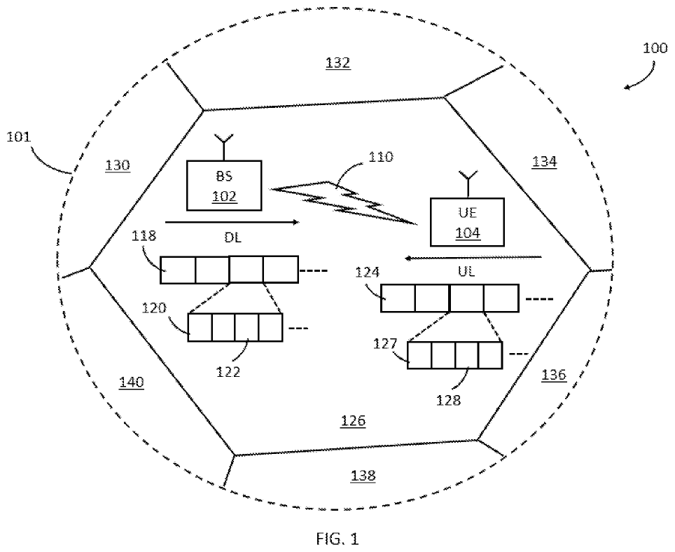

FIG. 1 illustrates an example wireless communication network and/or system 100, in accordance with an arrangement of the present disclosure. In the following discussion, the wireless communication network 100 may be any wireless network, such as a cellular network or a narrowband Internet of things (NB-IoT) network. The network 100 includes a Base Station (BS) 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are shown to be located within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various arrangements of the present solution.

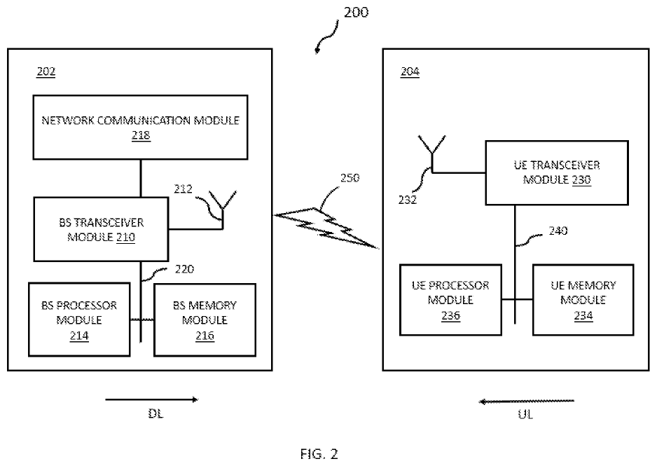

FIG. 2 illustrates a block diagram of an example wireless communication system 200 for transmitting and receiving wireless communication signals, e.g., OFDM/OFDMA signals, in accordance with some arrangements of the present solution. The system 200 may include components and elements configured to support known or conventional operating features that need not be described in detail herein. In one illustrative arrangement, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a BS transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some arrangements, the UE transceiver 230 may be referred to herein as an uplink transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the BS transceiver 210 may be referred to herein as a downlink transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some arrangements, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the BS transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various arrangements, the BS 202 may be an gNB, evolved node B (eNB), a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

Some arrangements relate to determining DMRS sequence mapping. In some examples in which some or all PBCH RB are punctured, the DMRS sequence is mapped to available DMRS REs in the SS/PBCH block, thus improving the integrity of the DMRS sequence mapping on the PBCH

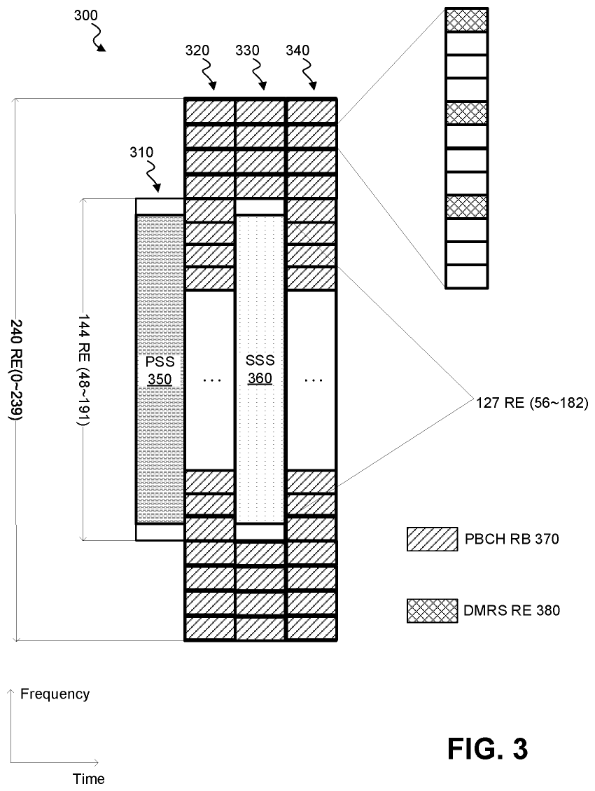

In some arrangements, a supported minimum bandwidth is no more than 5 MHz, and the frequency point does not exceed 3 GHz. For example, 3.6 MHz and/or 3 MHz are supported in the 0-1 GHz frequency range. In the narrowband scenario, a UE searches for one or more SS/PBCH blocks according to at least one frequency point. In some examples, the at least one frequency point can be defined by the specification or obtained using a suitable mechanism. FIG. 3 is a diagram illustrating an example of an SS/PBCH block 300, according to various arrangements. In FIG. 3, the horizontal axis corresponds to the time domain, and the vertical axis corresponds to the frequency domain. The SS/PBCH block 300 includes at least 4 time-domain symbols 310, 320, 330, and 340. Each of the 4 time-domain symbols 310, 320, 330, and 340 maps to a respective one of PSS 350, SSS 360, PBCH RB 370, and DMRS RE 380. As shown, the time-domain symbol 310 maps to the PSS 350. The time-domain symbol 320 maps to the PBCH RBs 370. The time-domain symbol 330 maps to the PBCH RBs 370 and the SSS 360. The time-domain symbol 340 maps to the PBCH RBs 370. Each PBCH RB 370 includes 3 DMRS REs 380 as shown. The SS/PBCH block 300 includes at least one PBCH RB 370 in the frequency domain, and each of the at least one PBCH RB 370 contains 12 REs, of which 3 are DMRS REs 380. As shown, the SS/PBCH block 300 has a total time-domain length or bandwidth of 240 REs (e.g., RE0-RE239). The PSS 350 has a time-domain length of 144 REs (e.g., RE48-RE191). The SSS 360 has a time-domain length of 127 REs (e.g., RE56-RE192). At least some of the PBCH RBs 370 on one or both sides (e.g., the top side corresponding to high frequency band and the bottom side corresponding to low frequency band) of the SS/PBCH block 300 can be punctured. All or part of the punctured RBs are the RBs beyond the system bandwidth boundary. For example, when the lower frequency boundary of the SS/PBCH block 300 is aligned with the low frequency boundary of the system bandwidth, and the bandwidth the SS/PBCH block 300 is 4 RBs greater than the bandwidth of the system bandwidth, 4 RBs on the highest frequency (at the top side in FIG. 3) of the SS/PBCH block 300 are punctured. At least one DMRS RE 380 is included in a PBCH RB 370, and DMRS RE 380 is used to map the data of DMRS sequence. As referred to herein, a system bandwidth is or includes at least one of a bandwidth that can be used by the UE as predefined by the specification, a bandwidth that the base station allocates to the UE, a maximum bandwidth supported by the UE, or a minimum bandwidth supported by the UE.

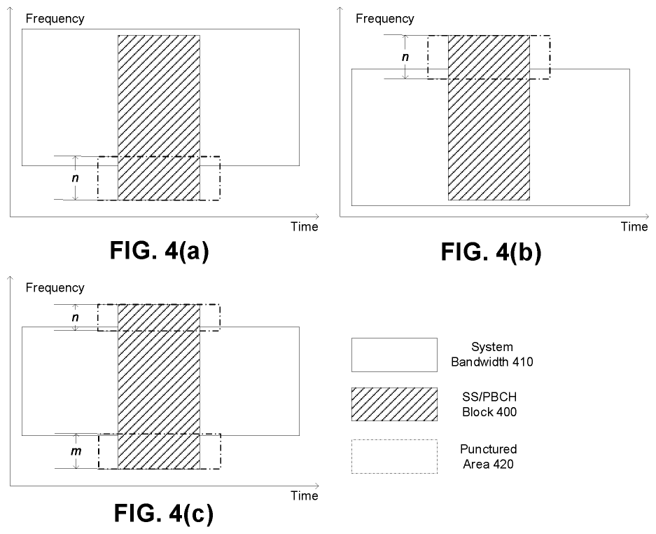

FIG. 4(a) is a schematic diagram illustrating an scenario in which at least one RB is punctures, according to various arrangements. As shown in FIG. 4(a), each of n RBs of an SS/PBCH block 400 has at least a portion that is outside of the system bandwidth 410. These n RBs correspond to the lowest frequency of the SS/PBCH block 400 and are located on a bottom side of the SS/PBCH block 400. These n RBs are punctured in the low frequency direction of the bandwidth of the SS/PBCH block 400. In some arrangements, the number n is predefined by the specification. Although the n punctured RBs are mapped to data of the SS/PBCH block 400, the UE does not accept those n RBs in some examples. In some examples, although the n punctured RBs are mapped to data of the SS/PBCH block 400, the BS does not send any data using those RBs.

FIG. 4(b) is a schematic diagram illustrating an scenario in which at least one RB is punctures, according to various arrangements. As shown in FIG. 4(b), each of n RBs of an SS/PBCH block 400 has at least a portion that is outside of the system bandwidth 410. These n RBs correspond to the highest frequency of the SS/PBCH block 400 and are located on a top side of the SS/PBCH block 400. These n RBs are punctured in the high frequency direction of the bandwidth of the SS/PBCH block. In some arrangements, the number n is predefined by the specification. As discussed above, although the n punctured RBs are mapped to data of the SS/PBCH block 400, the UE does not accept those n RBs in some examples. In some examples, although the n punctured RBs are mapped to data of the SS/PBCH block 400, the BS does not send any data using those RBs.

FIG. 4(c) is a schematic diagram illustrating an scenario in which at least one RB is punctures, according to various arrangements. As shown in FIG. 4(c), each of m RBs of the SS/PBCH block 400 has at least a portion that is outside of the system bandwidth 410, and each of n RBs of the SS/PBCH block 400 has at least a portion that is outside of the system bandwidth 410. These m RBs correspond to the lowest frequency of the SS/PBCH block 400 and are located on a bottom side of the SS/PBCH block 400. The m RBs are punctured in the low frequency direction of the bandwidth of the SS/PBCH block. These n RBs correspond to the highest frequency of the SS/PBCH block 400 and are located on a top side of the SS/PBCH block 400. The n RBs are punctured in the high frequency direction of the bandwidth the SS/PBCH block. In some arrangements, m and n is predefined by the specification. As discussed above, although the n punctured RBs are mapped to data of the SS/PBCH block 400, the UE does not accept those n RBs in some examples. In some examples, although the n punctured RBs are mapped to data of the SS/PBCH block 400, the BS does not send any data using those RBs.

As discussed with reference to FIG. 3, at least one DMRS RE is in each PBCH RB. For example, each PBCH RB include 3 DMRS REs. At least one of the following methods (Method 1, Method 2, Method 3, Method 4, and Method 5) can be used to determine the DMRS sequence mapping.

In Method 1, at least one parameter (e.g., at least one perforation parameter or at least one first parameter) that indicates a number (e.g., m, n, or so on) of punctured PBCH RBs on least one side of the bandwidth of the SS/PBCH block (e.g., 300 or 400) bandwidth is predefined by the specification. In some arrangements, a first parameter indicates a number (e.g., n in FIG. 4(b) and n in FIG. 4(c)) of punctured PBCH RBs on the top side (corresponding to high-frequency band) of the SS/PBCH block, and another first parameter indicates a number (e.g., n in FIG. 4(a) and m in FIG. 4(c)) of punctured PBCH RBs on the bottom side (corresponding to low-frequency band) of the SS/PBCH block. In some arrangements, a range of values (e.g., 1−x) of a first parameter indicates a number (e.g., n in FIG. 4(b) and n in FIG. 4(c)) of punctured PBCH RBs on the top side (corresponding to high-frequency band) of the SS/PBCH block, and another range of values (e.g., x+1−y) of the same first parameter indicates a number (e.g., n in FIG. 4(a) and m in FIG. 4(c)) of punctured PBCH RBs on the bottom side (corresponding to low-frequency band). In some arrangements, a first parameter may have a value that is different from m or n which the first parameter indicates.

The UE can receive the at least one first parameter from the network (e.g., the BS). The data of the DMRS sequence is mapped to the DMRS REs in PBCH RBs that are different from those indicated by the at least one first parameter based on a prerequisite of the original code rate. The original code rate is determined by the base station or predefined in the protocol/specification. In some examples in which there are not enough DMRS REs for DMRS sequence mapping, the part of the DMRS sequence that cannot be mapped to the DMRS REs is dropped, ignored, or not considered. In other words, a part of the DMRS sequence that has failed to be mapped to the DMRS REs based on a code rate is dropped.

In some arrangements, a first parameter may have a value that is the same as m or n which the first parameter indicates. In other words, the number of the punctured PBCH RBs on at least one side of the bandwidth of the SS/PBCH block is predefined by the specification, instead of another parameter that indicates the number.

Thus, in some examples, determining that the portion of the bandwidth of the SS/PBCH block is outside of the bandwidth of the system bandwidth includes receiving, by the UE from the BS, a first parameter indicating a number of PBCH RBs each having at least a portion that is outside of the bandwidth of the system bandwidth. The portion of the bandwidth of the SS/PBCH block that is outside of the bandwidth of the system bandwidth includes the number of PBCH RBs.

In Method 2, at least one parameter (e.g., perforation parameter or the at least one first parameter) that indicates a number (e.g., m, n, or so on) of punctured PBCH RBs on least one side of the bandwidth of the SS/PBCH block (e.g., 300 or 400) bandwidth is predefined by the specification. In some arrangements, a first parameter indicates a number (e.g., n in FIG. 4(b) and n in FIG. 4(c)) of punctured PBCH RBs on the top side (corresponding to high-frequency band) of the SS/PBCH block, and another first parameter indicates a number (e.g., n in FIG. 4(a) and m in FIG. 4(c)) of punctured PBCH RBs on the bottom side (corresponding to low-frequency band) of the SS/PBCH block. In some arrangements, a range of values (e.g., 1−x) of a first parameter indicates a number (e.g., n in FIG. 4(b) and n in FIG. 4(c)) of punctured PBCH RBs on the top side (corresponding to high-frequency band) of the SS/PBCH block, and another range of values (e.g., x+1−y) of the same first parameter indicates a number (e.g., n in FIG. 4(a) and m in FIG. 4(c)) of punctured PBCH RBs on the bottom side (corresponding to low-frequency band). In some arrangements, a first parameter may have a value that is different from m or n which the first parameter indicates.

The UE can receive the at least one first parameter from the network (e.g., the BS). The data of the DMRS sequence is mapped to the DMRS REs in PBCH RBs that are different from those indicated by the at least one first parameter based on a prerequisite of the original code rate. In some examples in which there are not enough DMRS REs for DMRS sequence mapping under the prerequisite of the original code rate, the code rate is increased until the entire DMRS sequence can be fully mapped to the DMRS RE. Accordingly, all DMRS sequence data can be transmitted even if the PBCH RB is punctured. In other words, if a part of the DMRS sequence has failed to be mapped to the DMRS REs based on a code rate, the code rate is increased until an entirety of the DMRS sequence is mapped to the DMRS REs.

In Method 3, the DMRS sequence is first mapped to the DMRS REs of PBCH RBs that have bandwidths that are within the bandwidth of or corresponding to the PSS 350 and/or SSS 360. The mapping can be performed according to a suitable mechanism predefined by the specification. In some arrangements, a time domain symbol is mapped to a low frequency symbol first and then to a high frequency symbol. Next, the remaining DMRS sequence is mapped to DMRS REs that are outside of the bandwidth of or corresponding to the PSS 350 and/or SSS 360 according to the same mechanism. The PBCH bandwidth should not be less than PSS/SSS. Accordingly, important data of DMRS sequences can be preferentially mapped first to the DMRS REs of PBCH RBs that have bandwidths that are within the bandwidth of or corresponding to the PSS 350 and/or SSS 360 to ensure that the important data is not punctured. In other words, the SS/PBCH block further includes the PSS and the SSS. The mapping between the DMRS sequence and the DMRS REs includes that 1) first DMRS REs of the DMRS REs having bandwidth entirely within at least one of a bandwidth of the PSS or a bandwidth of SSS are mapped to a first portion of the DMRS sequence, and subsequently 2) second DMRS REs of the DMRS REs having bandwidth entirely outside of the at least one of the bandwidth of the PSS or the bandwidth of SSS are mapped to a second portion of the DMRS sequence.

In Method 4, the DMRS sequence is mapped to only available DMRS REs, e.g., the DMRS REs that have not been punctured. The available DMRS REs can defined by the protocol in some arrangements. In some arrangements, the available DMRS REs are the remaining available DMRS RE resources after some DMRS RE resources have been punctured. Thus, in some examples, the portion of the bandwidth of the SS/PBCH block that is outside of the bandwidth of the system bandwidth correspond to unavailable DMRS REs, and the DMRS REs comprises unavailable DMRS REs and available DMRS REs, wherein the DMRS sequence is mapped to the available REs.

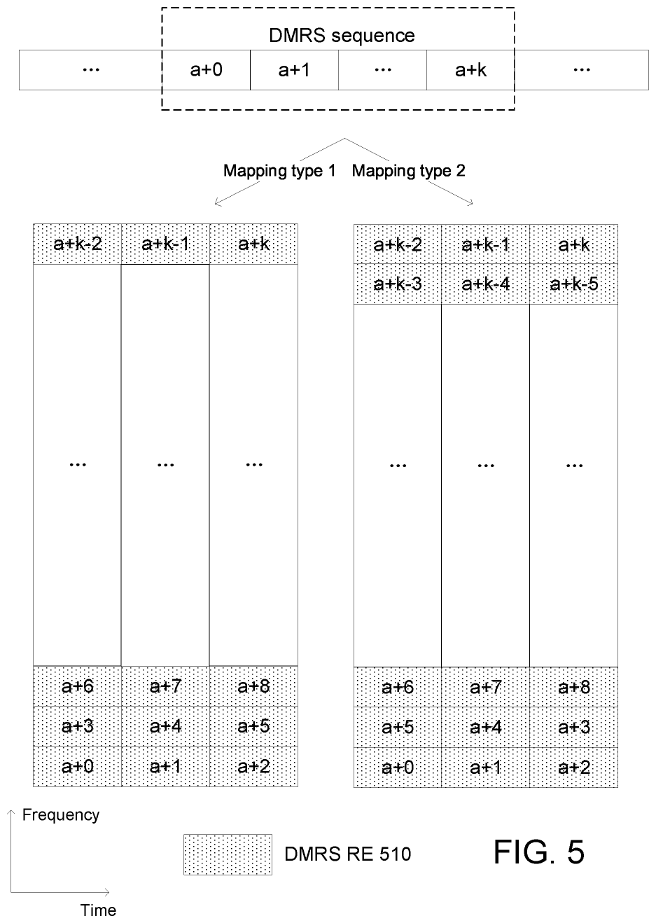

In Method 5, the mapping order in which elements of the DMRS sequence is mapped to the DMRS RE is predefined by the specification. In some arrangements, the elements of the DMRS sequence is mapped to the DMRS REs according to a chronological order in which the elements of the DMRS sequence are arranged. FIG. 5 is a diagram illustrating an example mapping method for mapping elements a+0, a+1, . . . , a+k of the DMRS sequence to DMRS REs 510, according to various arrangements. As shown in FIG. 5, the elements of the DMRS sequence are first mapped to the DMRS REs 510 in the low-frequency RBs in chronological order. Next, the elements of the DMRS sequence are mapped to the DMRS REs 510 in the high-frequency RBs in chronological order. The elements in the DMRS sequence correspond to the DMRS REs 510 one-by-one. That is, each element of the DMRS sequence maps to a corresponding one of the DMRS REs 510. As shown in FIG. 5, mapping type 1 corresponds to mapping the indexes of the elements of the DMRS sequence in ascending order in the frequency domain as frequency increases. Mapping type 2 corresponds to mapping the indexes of the elements of the DMRS sequence in both ascending order (e.g., a+0, a+1, a+2) and descending order (e.g., a+5, a+4, and a+3) in the frequency domain as frequency increases. In that regard, each of elements of the DMRS sequence is mapped to a corresponding one of the DMRS REs according to a chronological order of the elements of the DMRS sequence and frequency of the DMRS REs.

Based on Methods 1-5, when a portion of a PBCH RB is punctured, Methods 1-5 can ensure that the DMRS sequence is not divided into two or more different sequences. The fewer the number of divided sequences, the better the decoding performance. Accordingly, PBCH performance can be enhanced.

Some arrangements relate to determining a first resource to ensure that the CCE can be mapped to the system bandwidth in scenarios in which the bandwidth of the CORESET0 is no less than the system bandwidth.

In some arrangements relating to a narrowband scenario, a supported minimum bandwidth is less than 5 MHz, and the frequency point does not exceed 3 GHz. For example, 3.6 MHz and/or 3 MHz are supported in the 0-1 GHz frequency range. In the narrowband scenario, a UE receives from the BS and stores the available system bandwidth information and obtains the CORESET0 bandwidth information through decoding the PBCH. In some examples, the available system bandwidth is no larger than the CORESET0 bandwidth. The system bandwidth information includes at least one of bandwidth size, a start position of the system bandwidth, an end position of the system bandwidth, an offset with respect to a reference point. The CORESET0 bandwidth information includes at least one of a bandwidth size, a start position of the CORESET0 bandwidth, an end position of the CORESET0 bandwidth, an offset with respect to a reference point.

In some arrangements, the BS configures a resource for the UE explicitly or implicitly. In the example in which the configured resources overlap with the system bandwidth, the BS matches the rate of the overlapping resource. The first resource is the overlapping resource. The BS transmits or receives signals at a higher code rate in the first resource.

In some arrangements, the BS configures a resource for the UE explicitly or implicitly. In the example in which the configured resources overlap with the system bandwidth, the BS matches the rate of the non-overlapping resource. The first resource is the non-overlapping resource. The BS transmits or receives signals at a higher code rate in the first resource.

In some arrangements, the BS configures a first resource for the UE explicitly or implicitly. The CCEs are mapped to only the first resources.

In some arrangements, the BS configures a resource for the UE explicitly or implicitly. In the example in which the configured resource overlaps with the system bandwidth, CCEs are mapped to only the non-overlapping resources. The first resource is the non-overlapping resource.

In some arrangements, the BS configures a resource for the UE explicitly or implicitly. In the example in which the configured resource overlaps with the system bandwidth, CCEs are mapped to only the overlapping resources. The first resource is the overlapping resource.

At least one of the following methods (Method 1, Method 2, Method 3, Method 4, Method 5, Method 6, and Method 7) can be used to determine a resource to ensure that the PDCCH can be mapped to the system bandwidth in scenarios in which the CORESET0 bandwidth is not less than the system bandwidth.

In Method 1, the specification predefines the first resource according to the CORESET0 bandwidth and the system bandwidth. An overlapping resource that is within an overlapping region between the CORESET0 bandwidth and the system bandwidth is the first resource. In some arrangements, the first resource is an overlapping resource within an overlapping region between a bandwidth of CORESET0 and the system bandwidth.

In Method 2, the specification predefines a second resource. The first resource includes 1) the non-overlapping resource that is within an overlapping region between the CORESET0 bandwidth and the system bandwidth and 2) the second resource. The second resource can be at least one of a system bandwidth, a minimum system bandwidth, a maximum system bandwidth, a CORESET0 bandwidth, a Bandwidth Part (BWP) configured for the UE, a SS/PBCH bandwidth, and the overlapping resource that is within an overlapping region between the CORESET0 bandwidth and the system bandwidth. In some arrangements, the first resource includes 1) an overlapping resource within an overlapping region between a bandwidth of CORESET0 and a system bandwidth, and 2) a second resource. The second resource is at least one of the system bandwidth, a minimum system bandwidth, a maximum system bandwidth, a CORESET0 bandwidth, a BWP configured for the wireless communication device, a bandwidth of the SS/PBCH, and the overlapping resource that is within the overlapping region between the bandwidth of the CORESET0 and the system bandwidth.

In Method 3, the UE receives a Master Information Block (MIB) that indicates information or attributes of the first resource. The information or attributes of the first resource includes at least one of a frequency start point of the first resource, frequency end point of the first resource, number of RBs of the first resource, and number of REs of the first resource. The UE obtains the information or attributes by decoding the MIB. Accordingly, the UE receives from the BS a MIB that indicates that indicates attributes of the first resource. The attributes include one or more of a frequency start point of the first resource, a frequency end point of the first resource, a number of RBs of the first resource, and number of REs of the first resource.

In Method 4, the UE determines a first offset predefined by the specification. In some arrangements, the UE determines the first resource according to a second bandwidth and the first offset. For example, the first offset can indicate a number of RBs starting from or with reference to the low-frequency boundary of the second bandwidth, and the first resource is from the RB indicated by lower-frequency boundary of the second bandwidth offset by the first offset toward the high-frequency boundary of the second bandwidth. The second bandwidth can be at least one of a system bandwidth, a minimum system bandwidth, a maximum system bandwidth, a CORESET0 bandwidth, a BWP configured for the UE, and a SS/PBCH bandwidth. In some arrangements, the first resource is determined based on a first offset and a second bandwidth, and the first resource is the second bandwidth offset by the first offset.

In Method 5, the UE determines a first offset indicated by the MIB. In some arrangements, the UE determines the first resource according to a second bandwidth and the first offset. For example, the first offset can indicate the number of RBs starting from or with reference to the low-frequency boundary of the second bandwidth, and the first resource is from the RB indicated by lower-frequency boundary of the second bandwidth offset by the first offset toward the high-frequency boundary of the second bandwidth. The second bandwidth can be at least one of a system bandwidth, a minimum system bandwidth, a maximum system bandwidth, a CORESET0 bandwidth, a BWP configured for the UE, and SS/PBCH bandwidth. In some arrangements, the UE receives from the BS a MIB that indicates the first offset.

In Method 6, the specification pre-defines that the bandwidth of CORESET0 is the minimum or lesser of the number of RBs for CORESET0 and the number of RBs for the system BWP, e.g., min(N_{RB}^{CORESET 0},N_{RB}^{BWP}) as CORESET0 bandwidth. In some arrangements, a bandwidth of CORESET0 is the lesser of a number of RBs for CORESET0 and a number of RBs for a system BWP.

In Method 7, the specification pre-defines that the SS/PBCH block bandwidth after puncturing has occurred as CORESET0 bandwidth. In some arrangements, a bandwidth of CORESET0 is the bandwidth of the SS/PBCH block minus the portion of the bandwidth of the SS/PBCH block that is outside of the bandwidth of the system bandwidth.

Accordingly, the CCE can be mapped correctly when the CORESET0 bandwidth is not less than the system bandwidth.

In some arrangements, a boundary alignment can be determined in the examples in which the bandwidth of the CORESET0 is not less than the system bandwidth. The UE searches for the SS/PBCH block at a frequency point that is half of a bandwidth of the SS/PBCH block.

In some arrangements relating to a narrowband scenario, the minimum bandwidth supported is less than 5 MHz, and the frequency point does not exceed 3 GHz. For example, in a narrowband scenario, 3.6 MHz and/or 3 MHz is supported in the 0-1 GHz frequency range. A UE receives from the BS and stores the available system bandwidth information, and obtains the CORESET0 bandwidth information through decoding the PBCH. In some examples, the available system bandwidth is not greater than the CORESET0 bandwidth.

The system bandwidth information includes at least one of bandwidth size, a start position of the system bandwidth, an end position of the system bandwidth, an offset with respect to a reference point. The CORESET0 bandwidth information includes at least one of a bandwidth size, a start position of the CORESET0 bandwidth, an end position of the CORESET0 bandwidth, an offset with respect to a reference point.

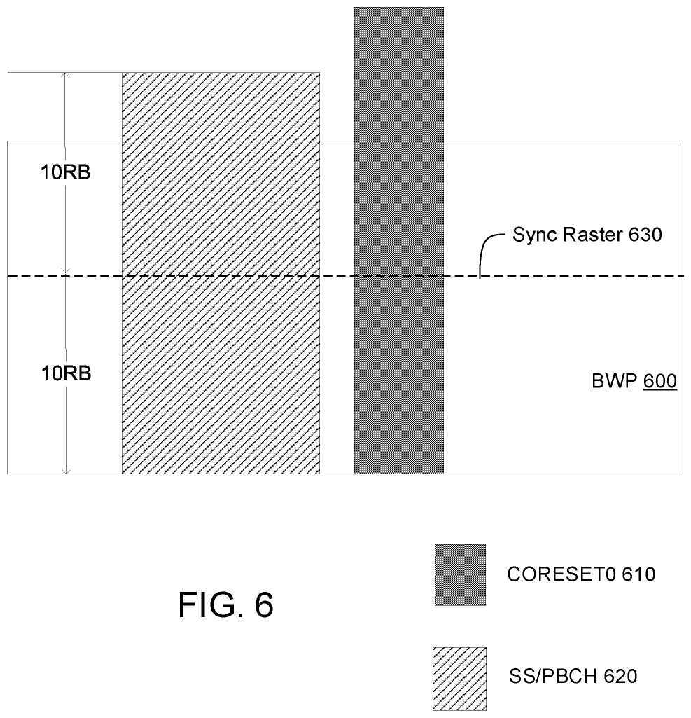

FIG. 6 is a diagram for determining boundary alignment, according to various arrangements. In some arrangements, the sync raster 630 in the narrowband scenario is predefined by the specification to be located at ½ of the bandwidth of the SS/PBCH block 620 away from the system bandwidth boundary of the BWP 600. That is, the UE searches the SS/PBCH block 620 at the frequency point of ½ of the bandwidth of the SS/PBCH block 620 away from the system bandwidth boundary. As show in FIG. 6, the offset value between CORESET0 610 and the SS/PBCH block 620 is 0.

In some arrangements, a second offset of CORESET0 and the SS/PBCH block predefined by the specification can be configured with negative values. The second offset includes at least one of an RB level and an RE level.

In some arrangements, the UE determines whether the SS/PBCH block detected by the UE meets the requirements in scenarios in which the SS/PBCH block bandwidth is no less than the system bandwidth.

In a scenario, the minimum bandwidth supported is no more than 5 MHz, and the frequency point does not exceed 3 GHz. For example, in a narrowband scenario, 3.6 MHz and/or 3 MHz is supported in the 0-1 GHz frequency range. In the narrowband scenario, a UE searches for SS/PBCH blocks according to at least one frequency point defined by the specification. The UE will detects at least one SS/PBCH block which meets the requirement in the system bandwidth.

In some arrangements, the first SS/PBCH block that meets the requirement is determined as a target SS/PBCH predefined by the specification, and the number of RBs that are punctured at each side of the SS/PBCH that meets the requirement is no be higher than a number is predefined by the specification. In some examples, the number is 4.

In some arrangements, the UE detects all SS/PBCH blocks in the system bandwidth, and identifies all SS/PBCH blocks which meet the requirement. The SS/PBCH block with the least number of punctured RBs is the target SS/PBCH block. If there are more than one SS/PBCH block with the same least number of punctured RBs, the optimal SS/PBCH block will be selected as the target SS/PBCH block. The optimal SS/PBCH block has at least one of following attributes: has the lowest frequency, has the highest frequency, is detected first, is nearest to the system bandwidth, and is nearest to the center of the system bandwidth.

In some arrangements, an offset to implement PUCCH frequency hopping is determined.

In a scenario, the minimum bandwidth supported is no more than 5 MHz and the frequency point does not exceed 3 GHz. For example, in a narrowband scenario, 3.6 MHz and/or 3 MHz is supported in the 0-1 GHz frequency range.

In some arrangements, a first offset predefined by the specification and indicates the number of RBs between the PUCCH frequency hopping point and the current frequency point.

In some arrangements, the first offset predefined by the specification, and the first offset is half of a number of RBs of a PUCCH bandwidth minus a number of RBs of the system bandwidth is.

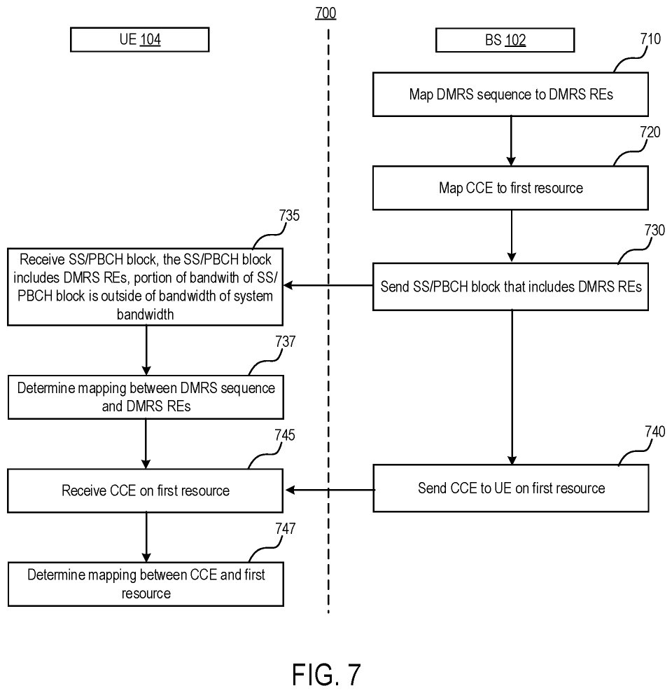

FIG. 7 is a flowchart diagram illustrating an example method 700 for determining demodulation reference signals, according to various arrangements. Referring to FIGS. 1-7, the method 700 can be performed by the UE 104 and the BS 102. In some examples, 710, 720, 730, and 740 can be performed in any suitable orders as long as 710 is performed before 730 and 720 is performed before 740. In some examples, 735, 737, 745, and 747 can be performed in any suitable orders as long as 735 is performed before 737 and 745 is performed before 747.

At 710, the BS 102 maps a DMRS sequence to the DMRS REs. For example, the BS 102 can map the DMRS sequence to the DMRS REs using one or more of Methods 1-5 for determining the DMRS sequence mapping.

At 720, the BS 102 maps a CCE to a first resource. For example, the BS 102 can map the DMRS sequence to the DMRS REs using one or more of Methods 1-5 for determining the resource to ensure that the PDCCH can be mapped to the system bandwidth in scenarios in which the CORESET0 bandwidth is not less than the system bandwidth.

At 730, the BS 102 sends the SS/PBCH block that includes DMRS REs to the UE 104. At 735, the UE 104 receives the SS/PDCH block from the BS 102. A portion of a bandwidth of the SS/PBCH block is outside of a bandwidth of a system bandwidth.

In some arrangements (e.g., those shown in FIGS. 4(a), 4(b), and 4(c)), the portion of the bandwidth of the SS/PBCH block that is outside of the bandwidth of the system bandwidth has a higher frequency range than a rest of the bandwidth of the SS/PBCH block, and/or the portion of the bandwidth of the SS/PBCH block that is outside of the bandwidth of the system bandwidth has a lower frequency range than the rest of the bandwidth of the SS/PBCH block.

In some arrangements, the portion of the bandwidth of the SS/PBCH block that is outside of the bandwidth of the system bandwidth correspond to unavailable DMRS REs. The DMRS REs include unavailable DMRS REs and available DMRS REs. The DMRS sequence is mapped to the available REs.

In some arrangements, the UE 104 can determine that a portion of the bandwidth of the SS/PBCH is outside of the bandwidth of the system bandwidth by receiving from the BS 102 a first parameter indicating a number of PBCH RBs each having at least a portion that is outside of the bandwidth of the system bandwidth. The portion of the bandwidth of the SS/PBCH block that is outside of the bandwidth of the system bandwidth includes the number of PBCH RBs.

In some arrangements, the first parameter has a value that is same as the number of the PBCH RBs each having at least the portion that is outside of the bandwidth of the system bandwidth. In other arrangements, the first parameter has a value that is different from the number of the PBCH RBs each having at least the portion that is outside of the bandwidth of the system bandwidth.

In some arrangements, a part of the DMRS sequence that has failed to be mapped to the DMRS REs based on a code rate is dropped. In other arrangements, if a part of the DMRS sequence has failed to be mapped to the DMRS REs based on a code rate, the code rate is increased until an entirety of the DMRS sequence is mapped to the DMRS REs.

In some arrangements, the SS/PBCH block further includes the PSS and the SSS. The mapping between the DMRS sequence and the DMRS REs includes that 1) first DMRS REs of the DMRS REs having bandwidth entirely within at least one of a bandwidth of the PSS or a bandwidth of SSS are mapped to a first portion of the DMRS sequence, and subsequently 2) second DMRS REs of the DMRS REs having bandwidth entirely outside of the at least one of the bandwidth of the PSS or the bandwidth of SSS are mapped to a second portion of the DMRS sequence.

In some arrangements, each of elements of the DMRS sequence is mapped to a corresponding one of the DMRS REs according to a chronological order of the elements of the DMRS sequence and frequency of the DMRS REs.

At 737, the UE 104 determines the mapping between the DMRS sequence and the DMRS REs of the SS/PBCH block.

At 740, the BS 102 sends the CCE to the UE 104 on the first resource. At 745, the UE 104 receives the CCE on the first resource from the BS 102. At 747, the UE 104 determines the mapping between CCE and the first resource.

In some arrangements, the first resource is an overlapping resource within an overlapping region between a bandwidth of CORESET0 and a system bandwidth.

In some arrangements, the first resource includes 1) an overlapping resource within an overlapping region between a bandwidth of CORESET0 and a system bandwidth, and 2) a second resource. The second resource is at least one of the system bandwidth, a minimum system bandwidth, a maximum system bandwidth, a CORESET0 bandwidth, a BWP configured for the wireless communication device, a bandwidth of the SS/PBCH, and the overlapping resource that is within the overlapping region between the bandwidth of the CORESET0 and the system bandwidth.

In some arrangements, the UE receives from the BS a MIB that indicates that indicates attributes of the first resource. The attributes include one or more of a frequency start point of the first resource, a frequency end point of the first resource, a number of RBs of the first resource, and number of REs of the first resource.

In some arrangements, the first resource is determined based on a first offset and a second bandwidth, and the first resource is the second bandwidth offset by the first offset. In some arrangements, the UE receives from the BS a MIB that indicates the first offset.

In some arrangements, a bandwidth of CORESET0 is the lesser of a number of RBs for CORESET0 and a number of RBs for a system BWP. In some arrangements, a bandwidth of CORESET0 is the bandwidth of the SS/PBCH block minus the portion of the bandwidth of the SS/PBCH block that is outside of the bandwidth of the system bandwidth.

The UE searches for the SS/PBCH block at a frequency point that is half of a bandwidth of the SS/PBCH block.

While various arrangements of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one arrangement can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
receiving, by a wireless communication device from a base station, a Synchronization Signal (SS)/Physical Broadcast Channel (PBCH) block, the SS/PBCH block comprising Demodulation Reference Signal (DMRS) Resource Elements (REs), wherein a portion of a bandwidth of the SS/PBCH block is outside of a bandwidth of a system bandwidth;
determining, by the wireless communication device, a mapping between a DMRS sequence and the DMRS REs; and
determining, by the wireless communication device, a mapping between a Control-Chanel Element (CCE) and a first resource.

2. The method of claim 1, wherein
the portion of the bandwidth of the SS/PBCH block that is outside of the bandwidth of the system bandwidth correspond to unavailable DMRS REs; and
the DMRS REs comprises unavailable DMRS REs and available DMRS REs, wherein the DMRS sequence is mapped to the available REs.

3. The method of claim 2, wherein determining that the portion of the bandwidth of the SS/PBCH block is outside of the bandwidth of the system bandwidth comprises receiving, by the wireless communication device from the base station, a first parameter indicating a number of PBCH Resource Blocks (RBs) each having at least a portion that is outside of the bandwidth of the system bandwidth, the portion of the bandwidth of the SS/PBCH block that is outside of the bandwidth of the system bandwidth comprises the number of PBCH RBs.

4. The method of claim 3, wherein the first parameter has a value that is same as the number of the PBCH RBs each having at least the portion that is outside of the bandwidth of the system bandwidth.

5. The method of claim 3, wherein the first parameter has a value that is different from the number of the PBCH RBs each having at least the portion that is outside of the bandwidth of the system bandwidth.

6. The method of claim 3, wherein a part of the DMRS sequence that has failed to be mapped to the DMRS REs based on a code rate is dropped.

7. The method of claim 3, wherein a part of the DMRS sequence has failed to be mapped to the DMRS REs based on a code rate, and the code rate is increased until an entirety of the DMRS sequence is mapped to the DMRS REs.

8. The method of claim 1, wherein
the SS/PBCH block further comprises Primary Synchronization Signal (PSS) and Secondary Synchronization Signal (SSS); and
the mapping between the DMRS sequence and the DMRS REs comprises:
first DMRS REs of the DMRS REs having bandwidth entirely within at least one of a bandwidth of the PSS or a bandwidth of SSS are mapped to a first portion of the DMRS sequence; and
then, second DMRS REs of the DMRS REs having bandwidth entirely outside of the at least one of the bandwidth of the PSS or the bandwidth of SSS are mapped to a second portion of the DMRS sequence.

9. The method of claim 1, wherein each of elements of the DMRS sequence is mapped to a corresponding one of the DMRS REs according to a chronological order of the elements of the DMRS sequence and frequency of the DMRS REs.

10. The method of claim 1, wherein the first resource is an overlapping resource within an overlapping region between a bandwidth of Control Resource Set (CORESET) for Type0 Physical Downlink Control Channel (PDCCH) Common Search Space (CSS) (CORESET0) and a system bandwidth.

11. The method of claim 1, wherein the first resource comprises an overlapping resource within an overlapping region between a bandwidth of Control Resource Set (CORESET) for Type0 Physical Downlink Control Channel (PDCCH) Common Search Space (CSS) (CORESET0) and a system bandwidth; and
a second resource, wherein the second resource is at least one of the system bandwidth, a minimum system bandwidth, a maximum system bandwidth, a CORESET0 bandwidth, a Bandwidth Part (BWP) configured for the wireless communication device, a bandwidth of the SS/PBCH, and the overlapping resource that is within the overlapping region between the bandwidth of the CORESET0 and the system bandwidth.

12. The method of claim 1, further comprising receiving, by the wireless communication device from the network, a Master Information Block (MIB) that indicates that indicates attributes of the first resource, wherein the attributes comprise one or more of a frequency start point of the first resource, a frequency end point of the first resource, a number of Resource Blocks (RBs) of the first resource, and number of REs of the first resource.

13. The method of claim 1, wherein the first resource is determined based on a first offset and a second bandwidth, and the first resource is the second bandwidth offset by the first offset.

14. The method of claim 13, further comprising receiving, by the wireless communication device from the network, a Master Information Block (MIB), wherein the MIB indicates the first offset.

15. The method of claim 1, wherein a bandwidth of Control Resource Set (CORESET) for Type0 Physical Downlink Control Channel (PDCCH) Common Search Space (CSS) (CORESET0) is the lesser of a number of Resource Blocks (RBs) for CORESET0 and a number of RBs for a system Bandwidth Part (BWP).

16. The method of claim 1, wherein a bandwidth of Control Resource Set (CORESET) for Type0 Physical Downlink Control Channel (PDCCH) Common Search Space (CSS) (CORESET0) is the bandwidth of the SS/PBCH block minus the portion of the bandwidth of the SS/PBCH block that is outside of the bandwidth of the system bandwidth.

17. The method of claim 1, further comprising searching for the SS/PBCH block at a frequency point that is half of a bandwidth of the SS/PBCH block.

18. A wireless communication device, comprising:
at least one processor configured to:
receive, via a receiver from a base station, a Synchronization Signal (SS)/Physical Broadcast Channel (PBCH) block, the SS/PBCH block comprising Demodulation Reference Signal (DMRS) Resource Elements (REs), wherein a portion of a bandwidth of the SS/PBCH block is outside of a bandwidth of a system bandwidth;
determine a mapping between a DMRS sequence and the DMRS REs; and
determine a mapping between a Control-Chanel Element (CCE) and a first resource.

19. Abase station, comprising:
at least one processor configured to:
map a Demodulation Reference Signal (DMRS) sequence to the DMRS REs;
map a Control-Chanel Element (CCE) to a first resource; and
send, via a transmitter to a wireless communication device, a Synchronization Signal (SS)/Physical Broadcast Channel (PBCH) block, the SS/PBCH block comprising DMRS Resource Elements (REs), wherein a portion of a bandwidth of the SS/PBCH block is outside of a bandwidth of a system bandwidth.

20. A wireless communication method, comprising:
mapping a Demodulation Reference Signal (DMRS) sequence to the DMRS REs;
mapping a Control-Chanel Element (CCE) to a first resource; and
sending, by a base station to a wireless communication device, a Synchronization Signal (SS)/Physical Broadcast Channel (PBCH) block, the SS/PBCH block comprising DMRS Resource Elements (REs), wherein a portion of a bandwidth of the SS/PBCH block is outside of a bandwidth of a system bandwidth.
